(19) United States
(12) Patent Application Publication
(10) Pub. No.: US 2006/0291765 A1
(43) Pub. Date: Dec. 28, 2006

(54) Roller bearing with gear assembly to synchronize races

(76) Inventors: John S. Hayward, Torrington, CT (US); Thomas R. Bober, Amston, CT (US); Daniel R. McLarty, Burlington, CT (US)

Correspondence Address: MICHAEL BEST & FRIEDRICH, LLP, 100 E WISCONSIN AVENUE, MILWAUKEE, WI, 53202, US

(21) Appl. No.: 10/553,690

(22) PCT Filed: Jan. 14, 2005
(86) PCT No.: PCT/US05/01289

§ 371 Date: Oct. 18, 2005

Related U.S. Application Data
(60) Provisional application No. 60/536,485, filed on Jan. 14, 2004.

(51) Int. Cl. F16C 33/48

(52) U.S. Cl. 384/572

(57) ABSTRACT

A roller bearing assembly (10) comprising radially inner and outer bearing races (20, 30) with a plurality of roller bearings (40) positioned therebetween. A first plurality of gear teeth (52) are provided in the outer bearing race (20). A second plurality of gear teeth (52) are provided in the inner bearing race (30) in alignment with the first plurality of gear teeth (52). A toothed gear (54) is positioned between and interengages with the first and second pluralities of gear

### BACKGROUND

The present invention relates to radial roller bearing assemblies. More particularly, the present invention relates to a radial roller bearing assembly with synchronized races.

Radial roller bearing assemblies typically comprise a plurality of rollers positioned between inner and outer races. A full complement of rollers may be positioned between the races or the rollers may be maintained by a bearing cage positioned between the races. The rollers serve to control friction between the two races. As one of the races moves relative to the other race, the rollers are free to roll between the races, thereby allowing the races to move independent of one another.

### SUMMARY

The present invention provides a roller bearing assembly comprising radially inner and outer bearing races with a plurality of roller bearings positioned therebetween. A first plurality of gear teeth are provided in the outer bearing race. A second plurality of gear teeth are provided in the inner bearing race in alignment with the first plurality of gear teeth. A toothed gear is positioned between and interengages with the first and second pluralities of gear teeth. As such, movement of one of the races causes movement of the gear which in turn causes movement of the other race, thereby synchronizing the movement of the inner and outer races.

### BRIEF DESCRIPTION OF THE DRAWINGS

FIG. 1 is an isometric view, in partial section, of a roller bearing assembly in accordance with a first embodiment of the present invention.

FIG. 2 is an isometric view of a portion of the gear support utilized in the roller bearing assembly of FIG. 1.

FIG. 3 is an isometric view of a bearing assembly incorporating roller bearing assemblies in accordance with a second embodiment of the present invention.

FIG. 4 is a top plan view of the bearing assembly of FIG. 3.

FIG. 5 is a sectional view along the line 5-5 in FIG. 4.

FIG. 6 is an exploded isometric view of a bearing assembly that is an alternative embodiment of the present invention.

FIG. 7 is an isometric view of the bearing assembly of FIG. 6 after assembly.

### DETAILED DESCRIPTION OF THE PREFERRED EMBODIMENTS

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

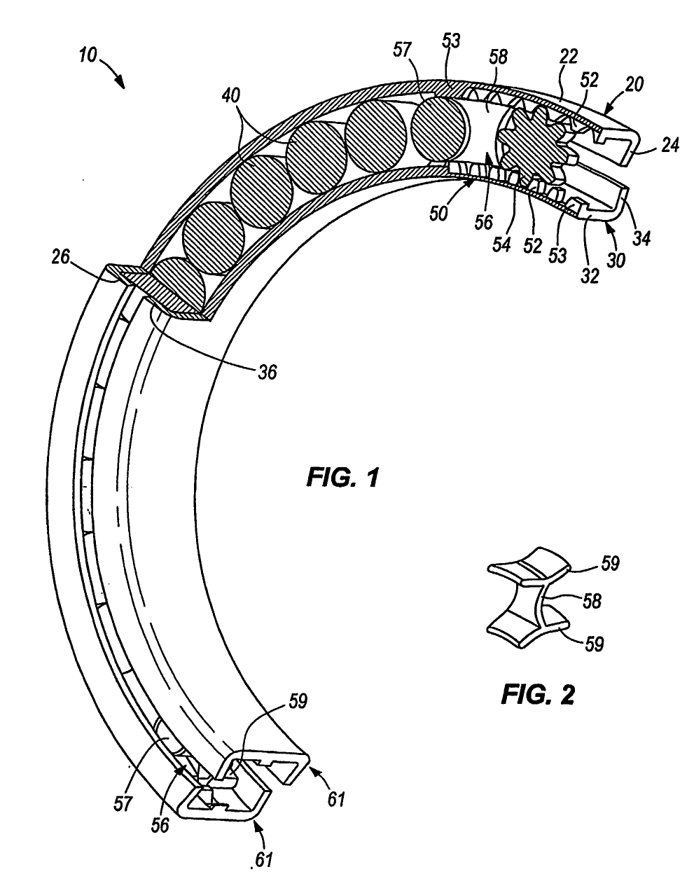

Referring to FIGS. 1 and 2, a roller bearing assembly 10 that is a first embodiment of the present invention is shown. The roller bearing assembly 10 generally comprises a plurality of rollers 40 positioned between opposed races 20 and 30. In the present embodiment, each race 20, 30 extends over an arc of approximately 180° as the roller bearing assembly 10 is configured for use in an oscillating application. However, the races 20, 30 are not limited to such, but instead can be provided at any desired arc, including a complete circle of 360° for rotational applications. Alternatively, the races 20 and 30 may also be flat, as opposed to arcuate as shown.

The outer race 20 has a planar arced surface 22 extending between radially inward flanges 24 and 26. Similarly, the inner race 30 has a planar arced surface 32 extending between radially outward flanges 34 and 36. The rollers 40 are configured to be positioned between the races 20 and 30 and are retained by the flanges 24, 26 and 34, 36. In the present embodiment, the rollers 40 are placed adjacent to one another without a cage positioned therebetween. However, a cage or the like can be provided if desired.

A gear assembly 50 is provided between the races 20 and 30 to synchronize the relative movement of the races 20 and 30. The gear assembly 50 includes a toothed gear 54 positioned between gear teeth 52 extending from the interior surface of each race planar surface 22, 32. The race gear teeth 52 can be formed into the race material itself by any suitable manufacturing process or the race gear teeth 52 may be manufactured as a separate component and installed and attached on the respective race surfaces 22, 32, for example, retained in a cavity manufactured into the race surface 22, 32. It is preferable that an enlarged tooth 53 is provided at each end of the race gear teeth 52 to serve as a stop and limit the range of movement of the gear 54 relative to the race gear teeth 52.

In the illustrated embodiment, the gear 54 has a length equal to the length of the rollers 40 such that the gear 54 is retained between the race flanges 24, 26 and 34, 36. Other mounting arrangements can also be provided. The toothed gear 54 and the race gear teeth 52 are configured to intermesh such that movement of one of the races 20 will cause movement of the gear 54 which in turn will cause movement of the other race 30, in a direction opposite the movement of the first race 20. It is contemplated that multiple stacked gears (not shown) can be provided between the race teeth 52 to control relative movement direction and gear ratios.

The gear assembly 50 of the present embodiment also includes a support assembly 56. The support assembly 56 includes a contact roller 57 and a bridge member 58. The contact roller 57 has a diameter such that the contact roller 57 fits between the inward extending race gear teeth 52. The bridge member 58 bridges between the gear 54 and the contact roller 57. As such, as the races 20 and 30 move relative to one another, the contact roller 57 and the bridge 58 will move between the race gear teeth 52 while maintaining the configuration of the rollers 40 and preventing undesired roller 40 contact with the race gear teeth 52.

Referring to FIG. 2, the bridge 58 preferably also includes axial wings 59. The wings 59 are configured to be received in crimpings 61 of the flanges 24, 26 and 34, 36. The flanges 24,26 and 34, 36 may be crimped after the components are positioned in between the races 20, 30 or the flanges 24, 26 and 34, 36 may be snap fit about the wings 59. With the flanges 24, 26 and 34, 36 engaging the wings 59, the races 20 and 30 are retained together, forming a unitized roller bearing assembly 10. As can be seen in FIG. 1, a support assembly 56 may be provided at the opposite ends of the races 20 and 30 to unitize that end of the races 20 and 30 and to provide added stability. A gear 54 may be provided at this end as well, but such is not required, as a single gear will synchronize the relative movement of the races 20 and 30.

The race gear teeth 52 are shown extending along only the end portions of the races 20, 30, however, it is understood that the race gear teeth 52 may be provided at various places along the entire arc of each race 20, 30. Additionally, multiple gears 54 may be provided in alignment with the race gear teeth 52 at various locations.

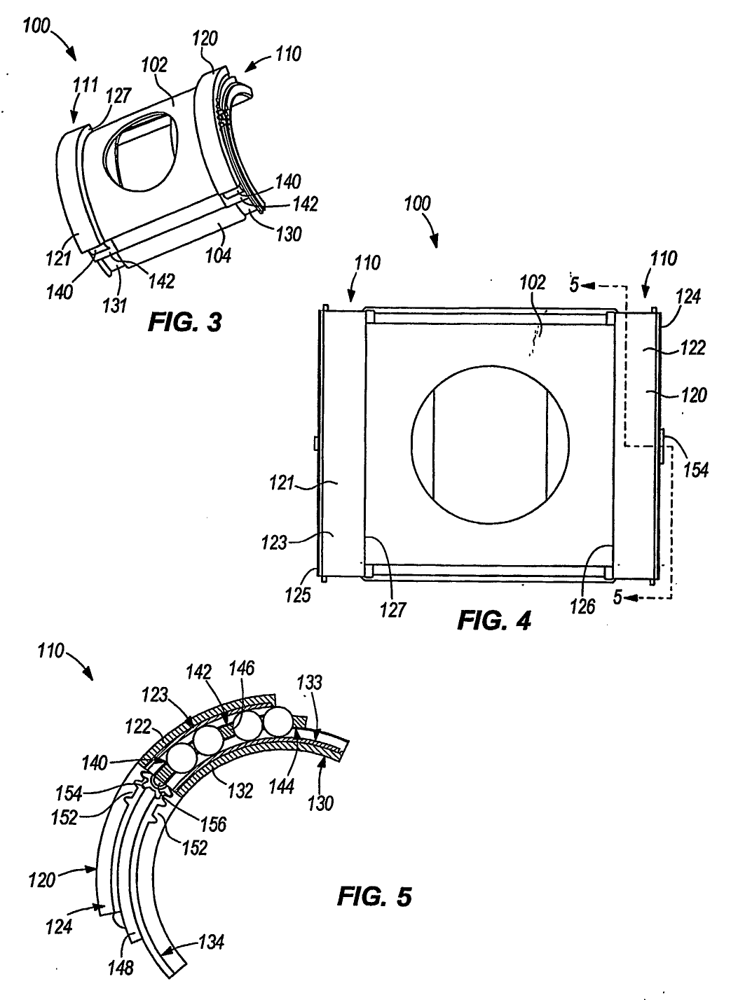

Referring to FIGS. 3-5, a bearing assembly 100 incorporating a pair of spaced apart roller bearing assemblies 110 and 111 is shown. Each roller bearing assembly 110, 111 includes outer races 120, 121 and inner races 130, 131, respectively. A connection plate 102 extends between the respective outer races 120, 121 and a connection plate 104 extends between the respective inner races 130, 131 to form a single bearing assembly 100 incorporating two roller bearing assemblies 110, 111. The connection plate 102 may be formed integral with the inner flanges 126, 127 of the respective outer races 120, 121, as with the inner connection plate 104 and the races 130, 131. Alternatively, the races 120, 121 and 130, 131 may be formed separate and later interconnected.

The first roller bearing assembly 110 will be described with reference to FIG. 5. The outer race 120 includes a planar arced surface 122 positioned between radially inwardly extending flanges 124 and 126. Similarly, the inner race 130 has a planar arced surface 132 extending between radially outward flanges 134 and 136. The axially outer flanges 124 and 134 are each provided with a series of race gear teeth 152. The race gear teeth 152 are preferably formed integrally in the flanges 124 and 134, for example, by molding each race 120, 130 with the teeth 152 formed in the flanges 124 and 134. In the event the races 120, 130 are molded from a softer material, for example a polymer, it is preferable to position a hardened raceway 123, 133, respectively, within each race 120, 130. The hardened raceways 123, 133 can be assembled to the races 120, 130 or insert molded with the races 120, 130 at the time of manufacture thereof. The inner flanges 126 of the races 120, 130 can be provided with gear teeth, but such is not required.

A plurality of rollers 140 are positioned between the raceways 123, 133 of the races 120 and 130. In the present embodiment, the rollers 140 are retained within a cage 142. The cage 142 includes a plurality of pockets 144 configured to receive and retain the rollers 140. The pockets 144 are defined by bars 146 extending between side rails 148.

A gear 154 is positioned between race flanges 124, 134 and is aligned and interengaged with the race gear teeth 152. The gear 154 is preferably supported by a spindle 156 or the like extending from the cage rail 148. The toothed gear 154 and the race gear teeth 152 are configured to intermesh such that movement of one of the races 120 will cause movement of the gear 154 which in turn will cause movement of the other race 130, in a direction opposite the movement of the first race 120. It is contemplated that multiple stacked gears (not shown) can be provided, for example on multiple spindles, between the race teeth 152 to control relative movement direction and gear ratios.

The second roller bearing assembly ill may be formed as a mirror image of roller bearing assembly 110 with a gear 154 provided between gear teeth 152 in its outer flanges 125 and 135 (not shown). However, since the upper races 120, 121 are interconnected and the lower races 130, 131 are interconnected, synchronization caused by gear 154 provided with the first roller bearing assembly 110 will cause synchronization of both roller bearing assemblies 110 and 111.

The race gear teeth 152 are shown extending along only a portion of the races 120, 130, however, it is understood that the race gear teeth 152 may be provided along the entire arc of each race 120, 130. Alternatively, the gear teeth 152 may be provided in multiple segments along the arc of the races 120, 130. Additionally, multiple gears 154 may be provided in alignment with the race gear teeth 152 at various locations.

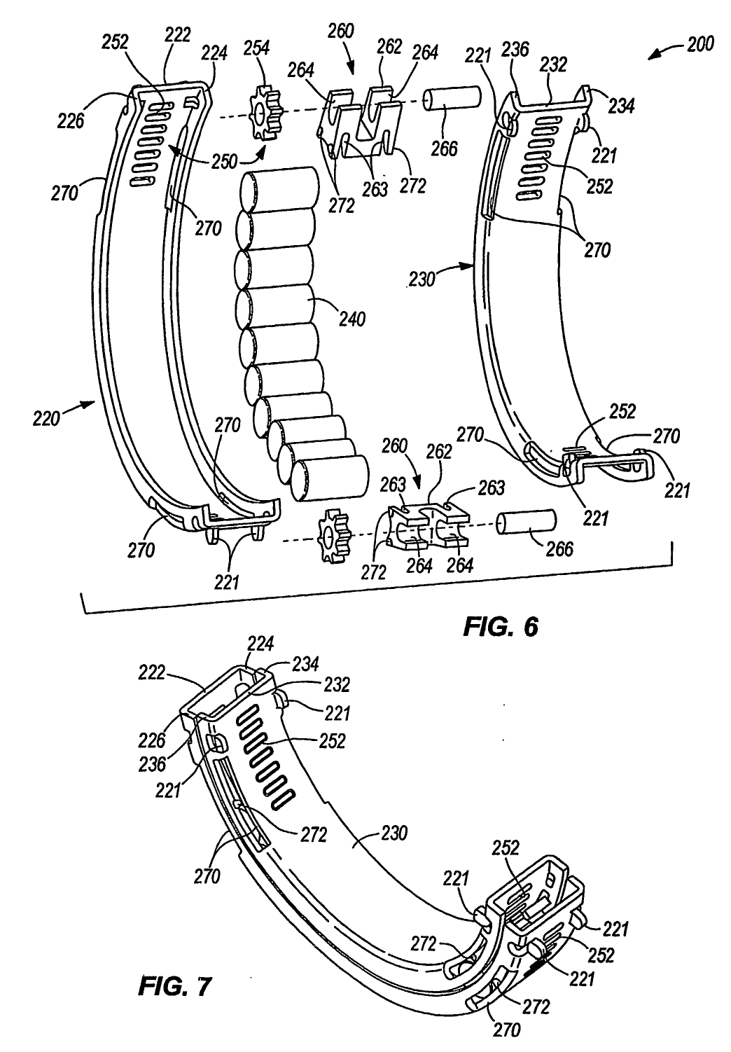

Referring to FIGS. 6 and 7, a roller bearing assembly 200 that is an alternate embodiment of the present invention is shown. The bearing assembly 200 is similar to the bearing assembly 10 of the first embodiment and includes a plurality of rollers 240 positioned between opposed races 220 and 230. In the present embodiment, each race 220, 230 extends over an arc of approximately 180° as the roller bearing assembly 200 is configured for use in an oscillating application. However, the races 220, 230 are not limited to such, but instead can be provided at any desired arc, including a complete circle of 360° for rotational applications. Alternatively, the races 220 and 230 may also be flat, as opposed to arcuate as shown.

The outer race 220 has a planar arced surface 222 extending between radially inward flanges 224 and 226. Similarly, the inner race 230 has a planar arced surface 232 extending between radially outward flanges 234 and 236. The rollers 240 are configured to be positioned between the races 220 and 230 and are retained by the flanges 224, 226 and 234, 236.In the present embodiment, the rollers 240 are placed adjacent to one another without a cage positioned therebetween, however, a cage or the like can be provided if desired. Each race 220, 230 is preferably formed with outwardly extending tabs 221, for example, during stamping of the races 220, 230. The tabs 221 provide assembly location and anti-rotation functions to both races 220, 230.

Gear assemblies 250 are provided between the races 220 and 230 to synchronize the relative movement of the races 220 and 230. Each gear assembly 250 of the present embodiment includes a toothed gear 254 aligned with a segment of gear teeth 252 in the planar surfaces 222, 232. In the present embodiment, the gear teeth 252 are pierced and coined into the race surfaces 222, 232 such that the gear teeth formed in the races 220, 230 do not extend above the raceway surfaces. This allows the rollers 240 to roll over the area of the gear teeth 252 without any interference. A smaller roller is not required in this embodiment. Additionally, the gear's root diameter can be made the same as the diameter of the rollers 240 such that the gear 254 extends from race surface 222 to race surface 232 and the gear 254 pilots on these surfaces 222, 232. The toothed gears 254 and the race gear teeth 252 are configured to intermesh such that movement of one of the races 220 will cause movement of the gear 254 which in turn will cause movement of the other race 230, in a direction opposite the movement of the first race 220. It is contemplated that multiple stacked gears (not shown) can be provided between the race teeth 252 to control relative movement direction and gear ratios.

A pair of gear holders 260 are provided to support the gears 254. Each gear holder 260 includes a body 262 with spaced apart shaft retainers 264. A shaft 266 is passed through a respective gear 254 and secured in the shaft retainers 264. Preferably, the gear holders 260 also serve to retain the opposed races 220, 230 together. Each race 220, 230 is formed with retention slots 270 adjacent the gear tooth areas at the junctures of the race surfaces 222, 232 and the respective flanges 224, 226 and 234, 236. The retention slots 270 are configured to receive retention tabs 272 extending axially from the ends of the gear holder body 262. The gear holder body 262 preferably has a slot 263 adjacent each retention tab 272 to provide for deflection of the tabs 272 past the race flanges 224, 226, 234, 236 during assembly. Use of the retention tabs 272 and retention slots 270 eliminates the need for a secondary crimping operation and also allows for maximization of the roller 240 length between the flanges 224, 226 and 234, 236, thereby increasing the bearing's capacity.

1-18. (canceled)

19. A roller bearing assembly comprising:
first and second arcuate bearing races, the first bearing race having a first set of gear teeth and the second bearing race having a second set of gear teeth opposed to the first set of gear teeth;
a first toothed gear positioned between the first and second bearing races and interengaging the first and second sets of gear teeth;
a first gear support coupled with the first gear;
a second toothed gear positioned between the first and second bearing races and interengaging the first and second sets of gear teeth;
a second gear support coupled with the second gear; and
a plurality of rollers positioned between the first and second bearing races;
wherein the first and second gear supports are spaced apart to define ends of a pocket containing the plurality of rollers.

20. The roller bearing assembly of claim 19 wherein the first bearing race has a first bearing surface in contact with the rollers and the second bearing race has a second bearing surface in contact with the rollers.

21. The roller bearing assembly of claim 20 wherein the first set of gear teeth are pierced through the first bearing surface and the second set of gear teeth are pierced through the second bearing surface such that the first and second sets of gear teeth do not interfere with the first and second bearing surfaces.

22. The roller bearing assembly of claim 20 wherein the first set of gear teeth extend from the first bearing surface toward the second bearing race and the second set of gear teeth extend from the second bearing surface toward the first bearing race.

23. The roller bearing assembly of claim 22 wherein the plurality of rollers includes at least one reduced diameter roller configured to travel between the first and second sets of gear teeth.

24. The roller bearing assembly of claim 20 wherein the first bearing race includes a first flange extending from the first bearing surface toward the second bearing race and the second bearing race includes a second flange extending from the second bearing surface toward the first bearing race in alignment with the first flange.

25. The roller bearing assembly of claim 24 further comprising a third flange extending from the first bearing surface toward the second bearing race and spaced from the first flange and a fourth flange extending from the second bearing surface toward the first bearing race in alignment with the third flange and wherein the plurality of rollers are retained between the first and third flanges and between the second and fourth flanges.

26. The roller bearing assembly of claim 25 wherein the gear supports are positioned between the first and second bearing races and the first and third flanges are crimped toward one another about the gear supports and the second and fourth flanges are crimped toward one another about the gear supports to retain the first and second bearing races together.

27. The roller bearing assembly of claim 25 wherein a first retention slot extends between the first flange and the first bearing surface, a second retention slot extends between the third flange and the first bearing surface, a third retention slot extends between the second flange and the second bearing surface, and a fourth retention slot extends between the fourth flange and the second bearing surface, and wherein the first gear support includes four axially extending tabs positioned between the first and second bearing races with each tab received in a respective one of the first, second, third and fourth retaining slots.

28. The roller bearing assembly of claim 27 wherein the first gear support includes a deflection slot adjacent each axially extending tab to provide for deflection of the tabs past the respective flanges during assembly.

29. The roller bearing assembly of claim 20 wherein the gear supports are each configured to support a shaft that supports the respective gear.

30. The roller bearing assembly of claim 20, wherein adjacent rollers of the plurality of rollers abut one another.

31. The roller bearing assembly of claim 20, wherein the plurality of rollers are supported between the gear supports without a roller cage.

32. The roller bearing assembly of claim 19 wherein the first and second bearing races each extend over an arc of at least approximately 180°.

33. The roller bearing assembly of claim 32 wherein the first and second bearing races each extend over an arc of approximately 360°.

34. A roller bearing assembly comprising:
first and second arcuate bearing races, the first bearing race having a first set of gear teeth and the second bearing race having a second set of gear teeth opposed to the first set of gear teeth, wherein the first set of gear teeth are pierced through a first bearing surface in the first bearing race and the second set of gear teeth are pierced through a second bearing surface in the second bearing race such that the first and second sets of gear teeth do not interfere with the first and second bearing surfaces;
a first toothed gear positioned between the first and second bearing races and interengaging the first and second sets of gear teeth;
a first gear support coupled with the first gear;
a second toothed gear positioned between the first and second bearing races and interengaging the first and second sets of gear teeth;
a second gear support coupled with the second gear; and
a plurality of rollers positioned between the first and second bearing races on the first and second bearing surfaces;
wherein the first and second gear supports are spaced apart to define ends of a pocket containing the plurality of rollers.

35. The roller bearing assembly of claim 34 wherein the gear supports are each configured to support a shaft that supports the respective gear.

36. The roller bearing assembly of claim 34, wherein adjacent rollers of the plurality of rollers abut one another.

37. The roller bearing assembly of claim 34, wherein the plurality of rollers are supported between the gear supports without a roller cage.

38. The roller bearing assembly of claim 34, wherein the first bearing race includes a first flange extending from the first bearing surface toward the second bearing race, the second bearing race includes a second flange extending from the second bearing surface toward the first bearing race in alignment with the first flange, the first bearing race includes a third flange extending from the first bearing surface toward the second bearing race, and the second bearing race includes a fourth flange extending from the second bearing surface toward the first bearing race in alignment with the third flange;
wherein the plurality of rollers are retained between the first and third flanges and between the second and fourth flanges; and
wherein a first retention slot extends between the first flange and the first bearing surface, a second retention slot extends between the third flange and the first bearing surface, a third retention slot extends between the second flange and the second bearing surface, and a fourth retention slot extends between the fourth flange and the second bearing surface, and wherein the first gear support includes four axially extending tabs positioned between the first and second bearing races with each tab received in a respective one of the first, second, third and fourth retaining slots.
